(19) United States
(12) Patent Application Publication
(10) Pub. No.: US 2016/0147909 A1
(43) Pub. Date: May 26, 2016

(54) 3D MODEL COMPONENT COMPARING SYSTEM AND METHOD THEREOF

(71) Applicants: INVENTEC (PUDONG) TECHNOLOGY CORPORATION, Shanghai City (CN); INVENTEC CORPORATION, Taipei City (TW)

(72) Inventors: CHUNG-SHENG NI, Taipei City (TW); CHIH-PIN WEI, Taipei City (TW); CHANG-HSIN CHIU, Taipei City (TW); CHUN-YING YANG, Taipei City (TW)

(21) Appl. No.: 14/793,268

(22) Filed: Jul. 7, 2015

(30) Foreign Application Priority Data
Nov. 26, 2014 (CN) 201410696050.8

(51) Int. Cl. G06F 17/50

(52) U.S. Cl. CPC G06F 17/50

(57) ABSTRACT

A 3D model component comparing system and method thereof are provided. The 3D model component comparing system includes a model-capturing unit, a processing unit, and a message-prompting unit. The model-capturing unit obtains a first model and a second model in a model design interface. The processing unit determines whether a plurality of component data of a plurality of components in components, which have the same component names, between the first model and the second model are all accordingly identical. The message-prompting unit outputs a renaming prompting message if the plurality of component data of the plurality of components in the components which have the same component names between the first model and the second model are not all accordingly identical. Thus design error rate is reduced.

### CROSS-REFERENCE TO RELATED APPLICATIONS

This non-provisional application claims priority under 35 U.S.C. §119(a) on Patent Application No. 201410696050.8 filed in China on Nov. 26, 2014, the entire contents of which are hereby incorporated by reference.

### BACKGROUND OF THE INVENTION

1. Technical Field of the Invention

The present invention relates to a system and a method for assisting model design, particularly to a 3D component comparing system and method thereof.

2. Description of the Related Art

As the advancement of the modern technology, various commercial products are brought to the market, and the structures of the products are getting more and more complex. Therefore, the time and costs of the product design become important keys in association with the success in the market.

Product design usually relies on the participation of various personnel of different areas, and the coordination between people is a big challenge during the design process. For example, if the designer does not grasp the detailed modifications between different versions during the design, it will result in unnecessary mistakes and modifications, and the costs of product design are increased.

In addition, a tiny modification of any component between different design versions may cost a lot of time and human resources for the comparison in advance when the complexity of the product structure increases, so that the design can be moved to the next stage. However, the comparison process usually lacks of a precise method and can only rely on the experiences of product designer and the observation of a naked eye.

### SUMMARY OF THE INVENTION

A 3D model component comparing system having a model design interface includes a model-capturing unit, a processing unit, and a message-prompting unit. The model-capturing unit is for capturing a first model and a second model in the model design interface. The processing unit is coupled to the model-capturing unit and is for determining whether a plurality of components with the same component names among the first model and the second model have a plurality of correspondingly identical component data. The message-prompting unit is coupled to the processing unit and is used for outputting a renaming prompting message when the one of plurality of components with the same component names in the first model and one of plurality of components with the same component names in the second model do not have the plurality of correspondingly identical component data.

In an embodiment, the processing unit further compares at least one first component with the same component name in the first model with at least one second component with the same component name in the second model, and determines whether the plurality of component data of at least one first component with the same component name and the plurality of component data of at least one second component with the same component name are correspondingly identical.

In an embodiment, the component datum is a component material, a component weight, a component geometric center, an assigned parameter of the component, or a combination thereof.

In an embodiment, the processing unit is further for reading an information weight priority in the model design interface and determining whether the plurality of component data of the at least one first component with the same component name and the plurality of component data of the at least one second component with the same component name are correspondingly identical one by one according to the information weight priority.

In an embodiment, the information weight priority is set according to a component material, a component weight, a component geometric center, and an assigned parameter of the component.

A 3D model component comparing method for a 3D model component comparing system having a model design interface includes capturing a first model and a second model in the model design interface, determining whether a plurality of components with the same component names among the first model and the second model have a plurality of correspondingly identical component data, and outputting a renaming prompting message when the one of plurality of components with the same component names in the first model and one of plurality of components with the same component names in the second model do not have the plurality of correspondingly identical component data.

In an embodiment, the step of determining whether a plurality of components with the same component names among the first model and the second model have a plurality of correspondingly identical component data further includes comparing at least one first component with the same component name in the first model with at least one second component with the same component name in the second model, and determining whether the plurality of component data of the at least one first component with the same component name and the plurality of component data of the at least one second component with the same component name are correspondingly identical.

In an embodiment, the component datum is a component material, a component weight, a component geometric center, an assigned parameter of the component, or a combination thereof.

In an embodiment, the step of determining whether the plurality of component data of the at least one first component with the same component name and the plurality of component data of the at least one second component with the same component name are correspondingly identical further includes reading an information weight priority in the model design interface, and determining whether the plurality of component data of the at least one first component with the same component name and the plurality of component data of the at least one second component with the same component name are correspondingly identical one by one according to the information weight priority.

In an embodiment, the information weight priority is set according to a component material, a component weight, a component geometric center, and an assigned parameter of the component.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a block diagram of the 3D model component comparing system according to an embodiment;

FIG. 2 is a flowchart of the 3D model component comparing method according to an embodiment;

FIG. 3 is a diagram of a plurality of components of the first model and the second model displayed in the model design interface according to an embodiment; and

FIG. 4 is a flowchart of the 3D model component comparing method according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

When a product designer wants to proceed to the next stage during the product design process, he has to figure out the commonality or difference between different design versions in order to ensure the correctness of the design. However, the product designer possibly makes mistakes during the product design process because components with different names but essentially with identical characteristics exist in different design versions. Therefore, the solution is specifically explained hereinafter.

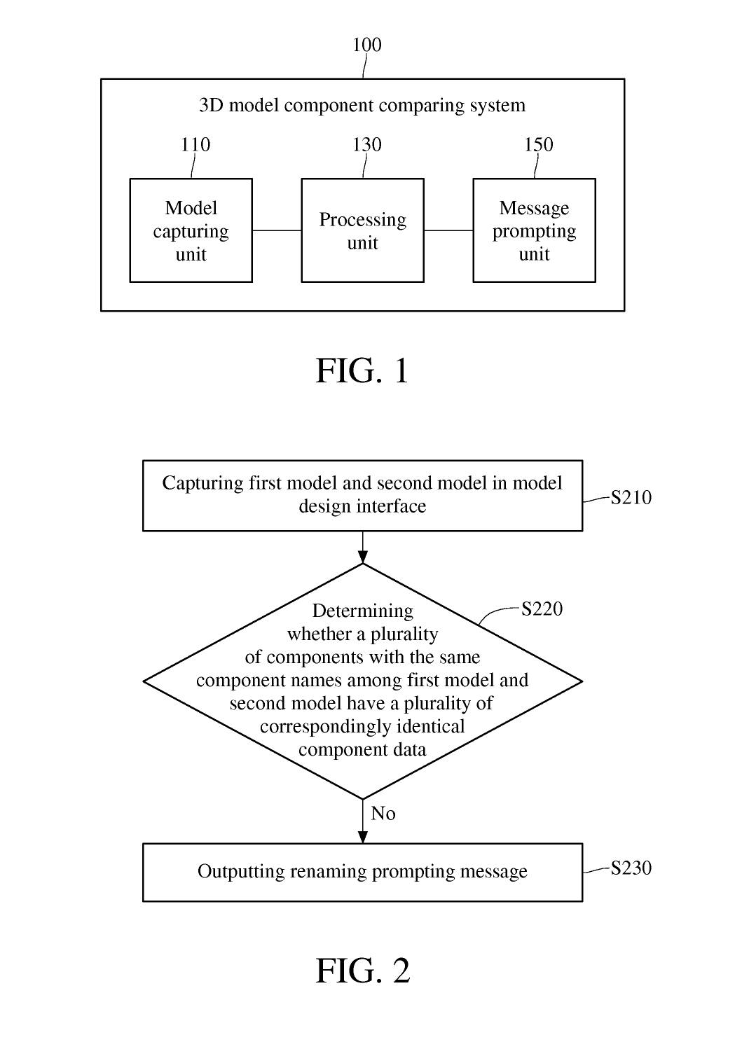

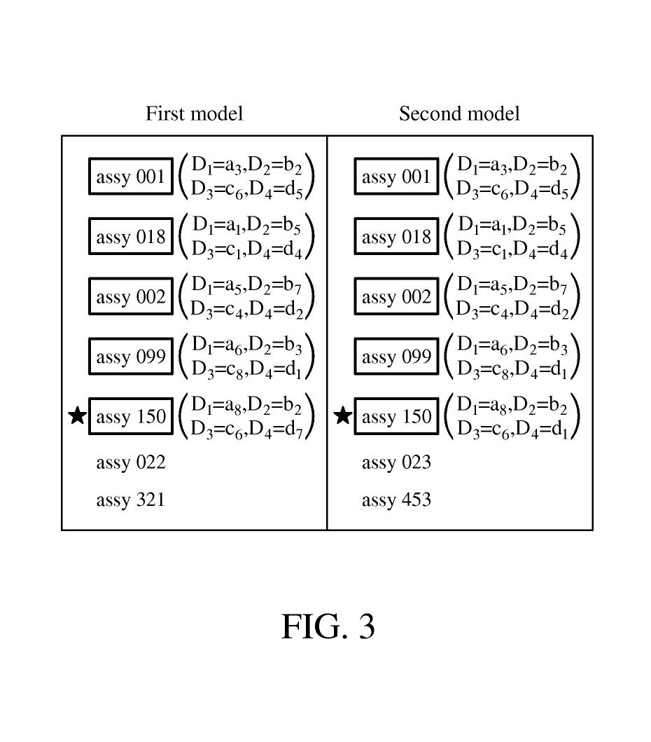

FIG. 1 is a block diagram of the 3D model component comparing system according to an embodiment. FIG. 2 is a flowchart of the 3D model component comparing method according to an embodiment. FIG. 3 is a diagram of a plurality of components of the first model and the second model displayed in the model design interface according to an embodiment. As shown in FIG. 1, the device 100 includes a model-capturing unit 110, a processing unit 130, and a message-prompting unit 150. The processing unit 130 is coupled to the model-capturing unit 110, and the message-prompting unit 150 is coupled to the processing unit 130. In the present embodiment, the model-capturing unit 110, the processing unit 130, and the message-prompting unit 150 are but not limited to various microprocessors or chips. As shown in FIG. 2, the 3D model component comparing method according to the present embodiment includes the steps S210, S220, and S230. Please refer to FIG. 1, FIG. 2, and FIG. 3 together as follows.

First, in step S210, the product designer captures the first model and the second model in the model design interface by the model-capturing unit 110. The first model and the second model include a plurality of components respectively. The first model and the second model are product models in different design versions during the product design process. For example, the first model is a prototype of the product provided by the upstream firms, and the second model is a modified product model after the downstream clients reviewed the prototype. In another example, the first model is a first-stage product model designed by the product designer A in the design team, and the second model is a second-stage product model designed by designer B based on the first-stage product model. The first model and the second model respectively have a plurality of components, and each of the plurality of components has a component name and a plurality of component data. The component name is the name named by the product designer, and the plurality of component data of the component stand for the essential characteristics of the component. In the present embodiment, the component datum is a component material, a component weight, a component geometric center, an assigned parameter of the component, or a combination of the previous data. The assigned parameter is, but not limited to, the color of the component or other component parameter. The product designer possibly gives an identical name to two components with different characteristics during the product design process.

After the first model and the second model are captured in the model design interface, in step S220, the processing unit 130 pairwisely compares the plurality of components of the first model with the plurality of components of the second model to determine whether a plurality of components with the same component names among the first model and the second model have a plurality of correspondingly identical component data. As shown in FIG. 3, the first model includes the components assy001, assy018, assy012, assy099, Assy150, assy022, and assy321, and the second model includes the components assy001, assy018, assy012, assy099, assy150, assy023, and assy453. The processing unit 130 finds out the first components with the same names and the second components with the same names assy001, assy018, assy012, assy099, and assy150. Next, the processing unit 130 determines whether the first components with the same names and the second components with the same names have a plurality of correspondingly identical component data. For example, between the first component with the same name and the corresponding second component with the same name, the processing unit 130 pairwisely compares the component data, such as the component material D1, the component weight D2, the component geometric center D3, and the assigned parameter of the component D4. In FIG. 3, the processing unit 130 determines that the component names of assy150 in the first model and assy150 in the second model are identical, but the plurality of component data of assy150 in the first model and the plurality of component data of assy150 in the second model are different. As shown in FIG. 3, the plurality of component data of assy150 in the first model are D1=a8, D2=b2, D3=c6, D4=d7, and the plurality of component data of assy150 in the second model are D1=a8, D2=b2, D3=c6, D4=d1.

Next, in step S230, when one of plurality of components with the same component names in the first model and one of plurality of components with the same component names in the second model do not have the plurality of correspondingly identical component data, the message-prompting unit 150 outputs a renaming prompting message. For example, as shown in FIG. 3, the method of outputting the renaming prompting message by the message-prompting unit 150 is marking the first component with the same name assy150 and the second component with the same name assy150 with stars in the component list of the first model and the component list of the second model in the model design interface. In another embodiment, the method of outputting the renaming prompting message by the message-prompting unit 150 is listing the first components with the same names and the second components with the same names, which do not have the plurality of correspondingly identical component data one by one in an extra independent list. In a further embodiment, the method of outputting the renaming prompting message by the message-prompting unit 150 is respectively marking the first components with the same names and the second components with the same names which do not have the plurality of correspondingly identical component data in the blueprint of the first model and the second model in the model design interface. Therefore, the message-prompting unit 150 outputs the renaming prompting message with various methods and the aforementioned embodiments are for illustrating but not for limiting the present invention.

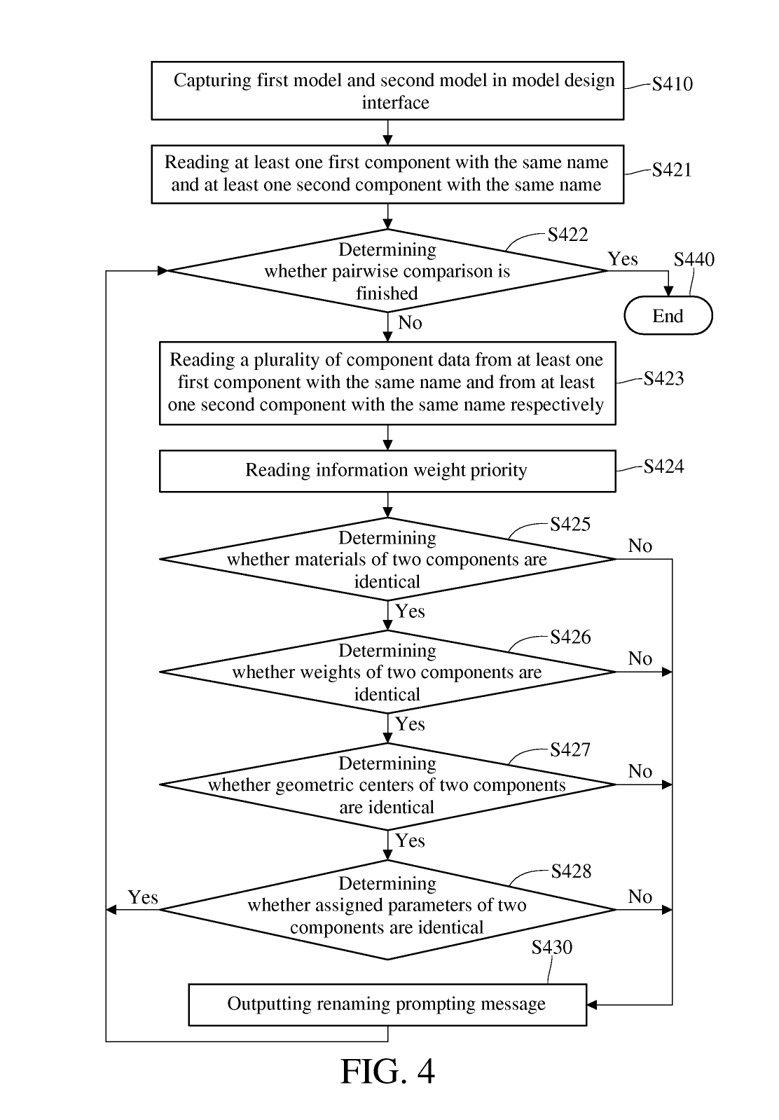

FIG. 4 is a flowchart of the 3D model component comparing method according to another embodiment. As shown in FIG. 4, the 3D model component comparing method in an embodiment includes the steps S410, S421˜S428, S430, and S440. Please refer to FIG. 1, FIG. 3, and FIG. 4 together as follows.

As the aforementioned explanation, in step S410, the product designer captures the first model and the second model in the model design interface provided by the model-capturing unit 110. In step S421, the processing unit 130 reads at least one first component with the same name and at least one second component with the same name from the first model and the second model.

Next, in step S422, the processing unit 130 determines whether the pairwise comparison between the at least one first component with the same name and the at least one second component with the same name is finished. When the comparison is not finished, step S423 is executed. When the comparison is finished, step S440 is executed to terminate the process.

In step S423, the processing unit 130 reads a plurality of component data from at least one first component with the same name and from at least one second component with the same name respectively. For example, the processing unit 130 reads a plurality of component data from the first component with the same name assy150 in the first model and from the second component with the same name assy150 in the second model respectively.

In step S424, the processing unit 130 reads an information weight priority in the model design interface. The information weight priority is set according to a component material, a component weight, a component geometric center, and an assigned parameter of the component.

In step S425, the processing unit 130 determines whether the materials of the two components read from the first component and the second component are identical. When the materials of the two components are identical, step S426 is further executed. When the materials of the two components are different, step S430 is executed. For example, when the processing unit 130 compares the material D1 of assy150 of the first component with the same name in the first model with the material D1 of assy150 of the second component with the same name in the second model and determines that the material D1 of assy150 of the first component with the same name in the first model and the material D1 of assy150 of the second component with the same name in the second model are both a8, step S426 is executed.

In step S426, the processing unit 130 determines whether the weights of the two components read from the first component and the second component are identical. When the weights of the two components are identical, step S427 is further executed. When the weights of the two components are different, step S430 is executed. For example, when the processing unit 130 compares the weight D2 of assy150 of the first component with the same name in the first model with the weight D2 of assy150 of the second component with the same name in the second model and determines that the weight D2 of assy150 of the first component with the same name in the first model and the weight D2 of assy150 of the second component with the same name in the second model are both b2, step S427 is executed.

In step S427, the processing unit 130 determines whether the geometric centers of the two components read from the first component and the second component are identical. When the geometric centers of the two components are identical, step S428 is further executed. When the geometric centers of the two components are different, step S430 is executed. For example, when the processing unit 130 compares the geometric center D3 of assy150 of the first component with the same name in the first model with the geometric center D3 of assy150 of the second component with the same name in the second model and determines that the geometric center D3 of assy150 of the first component with the same name in the first model and the geometric center D3 of assy150 of the second component with the same name in the second model are both c6, step S428 is executed.

In step S428, the processing unit 130 determines whether the assigned parameters of the two components read from the first component and the second component are identical. When the assigned parameters of the two components are identical, step S422 is executed again. When the assigned parameters of the two components are different, step S430 is executed. For example, when the processing unit 130 compares the assigned parameter D4 of assy150 of the first component with the same name in the first model with the assigned parameter D4 of assy150 of the second component with the same name in the second model and determines that the assigned parameter D4 of assy150 of the first component with the same name in the first model is d7 and the assigned parameter D4 of assy150 of the second component with the same name in the second model is d1 and d7 is different from d1, step S430 is executed.

In step S430, when the plurality of component data of the two components are different, the message-prompting unit 150 outputs the renaming prompting message, and repeatedly executes step S422 until the comparison is finished and the process is terminated.

In an embodiment, the comparison order of the material, the weight, the geometric center, and the assigned parameter of the component data in step S425, S426, S427, and S428 are respectively arranged according to the priority of each of the component data. For example, in the plurality of component data, the material has the highest priority, and the weight has the second highest priority, and the geometric center has the third highest priority, and the assigned parameter has the lowest priority. Therefore, the comparison order of the component data is material, weight, geometric center, and assigned parameter. In addition, arranging the comparison order according to the priority of the component data speeds up the comparison process.

In an embodiment, the model-capturing unit captures the first model and the second model in the model design interface. The processing unit obtains the first components with the same names in the first model and the second components with the same names in the second model, and pairwisely compares the first components with the same names in the first model with the second components with the same names in the second model according to information weight priority to determine whether the component data including the component material, the component weight, the component geometric center, and the assigned parameter of the component of the first component with the same name and the corresponding second component with the same name are identical. If not, the message-prompting unit outputs the renaming prompting message. Therefore, mastery of modifying the internal components resulting from the modified design version to the product designer is enhanced and the design error rate by multiple designers is reduced, so that unnecessary design mistakes and modifications are avoided and the design costs are further reduced.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A 3D model component comparing system having a model design interface, the 3D model component comparing system comprising:
a model-capturing unit for capturing a first model and a second model in the model design interface, the first model having a plurality of components and the second model having a plurality of components;
a processing unit coupled to the model-capturing unit, for determining whether the plurality of components with the same component names among the first model and the second model have a plurality of correspondingly identical component data; and
a message-prompting unit coupled to the processing unit, for outputting a renaming prompting message when one of plurality of components with the same component names in the first model and one of plurality of components with the same component names in the second model do not have the plurality of correspondingly identical component data.

2. The 3D model component comparing system of claim 1, wherein the processing unit further compares at least one first component with the same component name in the first model with at least one second component with the same component name in the second model, and determines whether the plurality of component data of the at least one first component with the same component name and the plurality of component data of the at least one second component with the same component name are correspondingly identical.

3. The 3D model component comparing system of claim 2, wherein the component datum is a component material, a component weight, a component geometric center, an assigned parameter of the component, or a combination thereof.

4. The 3D model component comparing system of claim 2, wherein the processing unit is further for reading an information weight priority in the model design interface and determining whether the plurality of component data of the at least one first component with the same component name and the plurality of component data of the at least one second component with the same component name are correspondingly identical one by one according to the information weight priority.

5. The 3D model component comparing system of claim 4, wherein the information weight priority is set according to a component material, a component weight, a component geometric center, and an assigned parameter of the component.

6. A 3D model component comparing method for a 3D model component comparing system, the 3D model component comparing system having a model design interface, the 3D model component comparing method comprising:
capturing a first model and a second model in the model design interface;
determining whether a plurality of components with the same component names among the first model and the second model have a plurality of correspondingly identical component data; and
outputting a renaming prompting message when the one of plurality of components with the same component names in the first model and one of plurality of components with the same component names in the second model do not have the plurality of correspondingly identical component data.

7. The 3D model component comparing method of claim 6, wherein the step of determining whether a plurality of components with the same component names among the first model and the second model have a plurality of correspondingly identical component data further comprises:
comparing at least one first component with the same component name in the first model with at least one second component with the same component name in the second model; and
determining whether the plurality of component data of the at least one first component with the same component name and the plurality of component data of the at least one second component with the same component name are correspondingly identical.

8. The 3D model component comparing method of claim 7, wherein the component datum is a component material, a component weight, a component geometric center, an assigned parameter of the component, or a combination thereof.

9. The 3D model component comparing method of claim 7, wherein the step of determining whether the plurality of component data of the at least one first component with the same component name and the plurality of component data of the at least one second component with the same component name are correspondingly identical further comprises:
reading an information weight priority in the model design interface; and
determining whether the plurality of component data of the at least one first component with the same component name and the plurality of component data of the at least one second component with the same component name are correspondingly identical one by one according to the information weight priority.

10. The 3D model component comparing method of claim 9, wherein the information weight priority is set according to a component material, a component weight, a component geometric center, and an assigned parameter of the component.
